(19) United States
(12) Patent Application Publication
(10) Pub. No.: US 2026/0266723 A1
(43) Pub. Date: Sep. 10, 2026

(54) SYSTEM AND METHOD FOR CALIBRATING AN OPTICAL IMAGING SYSTEM

(71) Applicant: VisionGate, Inc., Woodinville, WA (US)

(72) Inventors: Michael G. Meyer, Woodinville, WA (US); Alan C. Nelson, Woodinville, WA (US); Jon Hayenga, Woodinville, WA (US)

(21) Appl. No.: 19/558,263

(22) Filed: Mar. 5, 2026

Related U.S. Application Data
(60) Provisional application No. 63/768,064, filed on Mar. 6, 2025.
(60) Provisional application No. 63/767,937, filed on Mar. 6, 2025.

(51) Int. Cl. G01N 21/64

(52) U.S. Cl. CPC G01N 21/6428; G01N 2021/6439; G01N 2201/12784

(57) ABSTRACT

A system for calibrating an optical imaging system includes a specimen preparation chamber, an inner capillary, and a plunger. The specimen preparation chamber contains cells suspended in an optical media. The cells suspended in the optical media of the specimen preparation chamber are advanced through the first port and the inner lumen of the inner capillary using the plunger. The plunger is configured to push the suspended cells through the first port and the inner lumen of the inner capillary, where the cells enter an optical path of the optical imaging system for three-dimensional imaging of the cells. The measurement is made by computing the score from the LuCED test for early lung cancer detection, which indicates cells with abnormal features with a higher score. By measuring cells within the capillary through the score, determining if a shift has arisen from malfunctions in the optical imaging system that requires service.

### BACKGROUND

### Technical Field

The present disclosure relates to a system and method for a calibration system, and more specifically, for a calibration system of an optical imaging system.

### DESCRIPTION OF THE RELATED ART

Lung cancer is the most lethal cancer in the United States, and over 31 million patients are at a high risk of developing lung cancer. Early detection is the most reliable means of reducing lung cancer deaths. Still, many detection methods have poor sensitivity and specificity, leading to missed diagnoses and, as a result, higher death rates, as well as increased costs and needless suffering caused by invasive procedures.

The Cell-CT is a high-precision optical imaging system that captures 3D images of biological cells at sub-micron resolution. However, its image quality depends on the proper optical alignment of 100x objective lenses with micron alignment sensitivities, which may move from use, thermal cycles, and vibration. To evaluate performance, tests measure resolution using line-pair targets and contrast using polystyrene beads. While these tests provide basic image quality indicators, the most reliable way to assess the system’s clinical effectiveness is by measuring its ability to analyze cells accurately.

### BRIEF SUMMARY

The present disclosure provides a calibration system for an optical imaging system. The calibration system includes a specimen preparation chamber, an inner capillary, and a plunger. The specimen preparation chamber contains cells suspended in an optical media. The specimen preparation chamber has a first port at a first end of the specimen preparation chamber and a second port at a second end of the specimen preparation chamber. The first end of the specimen preparation chamber is opposite of the second end of the specimen preparation chamber. The inner capillary is connected to the first port of the specimen preparation chamber. The inner capillary has an inner lumen. The cells suspended in the optical media of the specimen preparation chamber may be advanced through the first port and the inner lumen of the inner capillary by the plunger. The optical media of the specimen preparation chamber has the same refractive index as the inner capillary. The plunger is connected to the second port of the specimen preparation chamber. The plunger is controllable by an optical imaging system. The plunger is configured to push the suspended cells through the through the first port and the inner lumen of the inner capillary where the cells enter an optical path of the optical imaging system for imaging of the cells. The cells remain in a native three-dimensional shape in the inner capillary for imaging rather than being flattened into a two-dimensional shape on a slide, as occurs in a traditional 2-D slide imaging system.

In one or more embodiments of the calibration system, the inner capillary is configured to be threaded through an outer capillary of a specimen cartridge into a capillary imaging zone of the specimen cartridge. In another aspect of some embodiments, the outer capillary of the specimen cartridge has a flattened optically matched surface that attenuates any capillary curvature induced distortion. In still another aspect of some embodiments, the optical media of the specimen preparation chamber has the same refractive index as the specimen cartridge. In yet another aspect of some embodiments, the inner capillary has a first end and a second end, and the inner capillary receives suspended cells through the first end that are transferred from the optical media of the specimen preparation chamber. The inner capillary is removed from the specimen preparation chamber after receiving the suspended cells and sealed at the first end and the second end, after which the inner capillary is attached to the specimen preparation chamber with the fixed plunger.

In some embodiments of the calibration system, the cells are suspended in an optical media of the specimen preparation chamber are pulmonary macrophages, wherein the pulmonary macrophages are metabolically active and exhibit chromatin patterns similar to abnormal cells. In another aspect of some embodiments, the pulmonary macrophage cells suspended in the optical media of the specimen preparation chamber are enriched using a specialized biomarker. In still another aspect of some embodiments, the specialized biomarker is a MAC387 antibody marker with conjugated fluorophores.

In another embodiment, a calibration method for an optical imaging system is disclosed. The method includes: performing baseline testing of the optical imaging system using a specimen preparation chamber by collecting image sets for cells in the inner capillary that are within a capillary imaging zone of the specimen cartridge; generating a baseline abnormal score histogram from the abnormal classifier score using the cells imaged in the inner capillary within the capillary imaging zone; computing baseline variability of the abnormal classifier score by calculating a mean (μ) and standard deviation (σ) for all image sets of cells in the inner capillary that were collected; establishing a reference distribution by computing a mean (μrefdist) and a standard deviation (σrefdist) of the baseline abnormal score histogram; saving baseline testing information that includes the baseline abnormal score histogram, the mean (μrefdist), and the standard deviation (σrefdist); and performing calibration testing of the optical imaging system using a specimen preparation chamber by: (1) calculating calibration testing information that includes a new abnormal score histogram, a new mean (μtestdist), and new standard deviation (σtestdist); (2) comparing the calibration testing information to the baseline testing information; and (3) determining if the optical imaging system passes calibration testing using the comparison of the calibration testing information to the baseline testing information.

In one or more embodiments of the calibration method, a control system for the optical imaging system moves cells through the inner capillary using flow generated by the plunger, and mechanical motion of the specimen cartridge. In another aspect of some embodiments, an abnormal cell classifier of the optical imaging system includes a lower range, a middle range, and an upper range; and further comprising: selecting cells to be suspended in the optical media of the specimen preparation chamber that fall within the middle range of an abnormal cell classifier when calibrating an abnormal cell classifier of the optical imaging system. In still another aspect of some embodiments, at least thirty cells are imaged in the inner capillary within the capillary imaging zone having mean abnormal classifier scores between 0.2 and 0.8. In yet another aspect of some embodiments, if less than thirty cells are imaged in the inner capillary within the capillary imaging zone having mean abnormal classifier scores between 0.2 and 0.8, then the specimen preparation chamber is rejected. Furthermore, in another aspect of some embodiments, the computation of the baseline variability is calculated using cells with abnormal classifier scores between 0.2 and 0.8.

In one or more embodiments of the calibration method, an average standard deviation: avg(σ), is calculated and stored. In another aspect of some embodiments, the method further comprises using a coefficient of variance test to assess score stability. In a further aspect of this embodiment, failure of the coefficient of variance test triggers failure of the optical imaging system calibration, and recalibration of the optical imaging system. In another aspect of some embodiments, the method further comprises determining that the calibration test fails when a mean (μtestdist) shifts outside a range of μtestdist ± 3 × avg(σ). In yet another aspect of some embodiments, the method further comprises requiring a recalibration of the optical imaging system, in response to determining that the calibration test fails.

In still other embodiments, a calibration system for an optical imaging system is disclosed. The calibration system includes a specimen preparation chamber, an inner capillary, a plunger, and a calibration control system. The specimen preparation chamber contains cells suspended in an optical media. The specimen preparation chamber has a first port at a first end of the specimen preparation chamber and a second port at a second end of the specimen preparation chamber. The first end of the specimen preparation chamber is opposite of the second end of the specimen preparation chamber. The inner capillary is connected to the first port of the specimen preparation chamber. The inner capillary has an inner lumen. The cells suspended in the optical media of the specimen preparation chamber may be advanced through the first port and the inner lumen of the inner capillary by the plunger. The optical media of the specimen preparation chamber has the same refractive index as the inner capillary. The plunger is connected to the second port of the specimen preparation chamber. The plunger is controllable by an optical imaging system. The plunger is configured to push the suspended cells through the first port and the inner lumen of the inner capillary, where the cells enter an optical path of the optical imaging system for imaging of the cells. The cells remain in a native three-dimensional shape in the inner capillary for imaging rather than being flattened into a two-dimensional shape on a slide for imaging, as occurs in a traditional 2-D slide imaging system.

The calibration control system has a memory that stores computer-executable instructions and a processor that executes the computer-executable instructions and causes the processor to: perform baseline testing of the optical imaging system using a specimen preparation chamber by collecting image sets for cells in the inner capillary that are within a capillary imaging zone of the specimen cartridge; generate a baseline abnormal score histogram from the abnormal classifier score using the cells imaged in the inner capillary within the capillary imaging zone; compute baseline variability of the abnormal classifier score by calculating a mean (μ) and standard deviation (σ) for all image sets of cells in the inner capillary that were collected; establish a reference distribution by computing a mean (μrefdist) and a standard deviation (σrefdist) of the baseline abnormal score histogram; save baseline testing information that includes the baseline abnormal score histogram, the mean (μrefdist), and the standard deviation (σrefdist); and perform calibration testing of the optical imaging system using a specimen preparation chamber by: (1) calculate calibration testing information that includes a new abnormal score histogram, a new mean (μtestdist), and new standard deviation (σtestdist); (2) compare the calibration testing information to the baseline testing information; and (3) determine if the optical imaging system passes calibration testing using the comparison of the calibration testing information to the baseline testing information.

### BRIEF DESCRIPTION OF THE SEVERAL VIEWS OF THE DRAWINGS

The disclosure may be better understood through reference to the following detailed description in conjunction with the drawings, which are provided as examples only:

FIG. 1 is a representation of a calibration system for an optical tomography system that may be used in the present disclosure.

FIG. 2 is a histogram of the LuCED abnormal score for 20,640 macrophages, confirming that their scores fall within the middle range, in accordance with the present disclosure.

FIG. 3 is a logic diagram showing a method for calibrating an optical tomography system.

FIG. 4 is a schematic representation of an optical tomography system that may be used in the present disclosure.

FIG. 5 is a schematic representation of the optical tomography system as operated to acquire a plurality of 2D images of a cell that may be used in the present disclosure.

FIG. 6 is a flow chart for a lung cancer detection method of the present disclosure.

FIG. 7 is a system diagram that describes an example implementation of a computing system(s) for implementing embodiments described herein.

### DETAILED DESCRIPTION

The following description, along with the accompanying drawings, sets forth certain specific details to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components associated with the environment of the present disclosure have not been shown or described to avoid unnecessarily obscuring descriptions of the embodiments. Additionally, the various embodiments may be methods, systems, or devices.

The present disclosure relates to a calibration system for an optical imaging system, which may detect cells indicative of cancer among a plurality of cells in a lung-related patient sample, such as sputum. The cells indicative of cancer may be cancerous, but they may also include non-cancerous cells having abnormal features. In some embodiments, a sample may be designated as containing cells indicative of cancer (and thus positive for lung cancer) based solely on the detection of non-cancerous cells having abnormal features. When a sample is designated as containing cells indicative of cancer, the patient may be referred for further testing. The term “cancer” refers to a hyperproliferation of cells that results in unregulated growth, lack of differentiation, local tissue invasion, or metastasis. In some embodiments, the optical tomography system may be a CELL-CT^{®} system (VisionGate, Inc., Washington, USA).

The disclosed calibration system is for an optical imaging system that uses optical tomography, such as current optical tomography systems, to detect cells and generate 3D images of the cells. However, unlike existing optical tomography systems and methods, the system and method of the present disclosure, prior to generating a 3D image of a cell, first generate a representative 2D image of the cell and analyze the representative 2D image using AI-based 2D cell classifiers to determine if a 3D image should be generated. Patient samples contain a substantial number of diverse cells that are not likely indicative of lung cancer and, therefore, are not useful in detecting lung cancer. A 3D image of such cells is not needed, and generating it is a waste of resources. Avoiding unnecessary 3D imaging of cells that are not useful in detecting lung cancer allows for more efficient sample processing.

After manufacturing, alignment, or software updates, optical imaging system instruments are tested by analyzing A549 (adenocarcinoma) cultured lung cancer cells and normal reference cells. Cell image feature measurements are processed using classification algorithms to generate scores indicative of the cell type, which are used to create ROC [Receiver Operator Characteristic] curves that may be used to differentiate normal from abnormal cells. Multiple A549 cell culture and normal cell collection batches are tested to minimize bias from cell selection and growth conditions.

For standard lab operating procedures, a faster and more practical method is needed. This involves repeatedly processing the same cells on different instruments to measure repeatability and accuracy in classification scores. The proposed solution is based on a sealed capillary tube containing chemically fixed and stained cells that can be analyzed multiple times and on multiple instruments. With proper storage procedures, the cells will remain mechanically fixed and suspended within the imaging capillary so the same cells can be reimaged and measured multiple times, allowing for repeatable, accurate, and reliable system performance metrics.

Described herein is a method for creating a calibrated capillary sample that may be used in the disclosed calibration system to ensure imaging remains consistently above requirements for cell recognition performance.

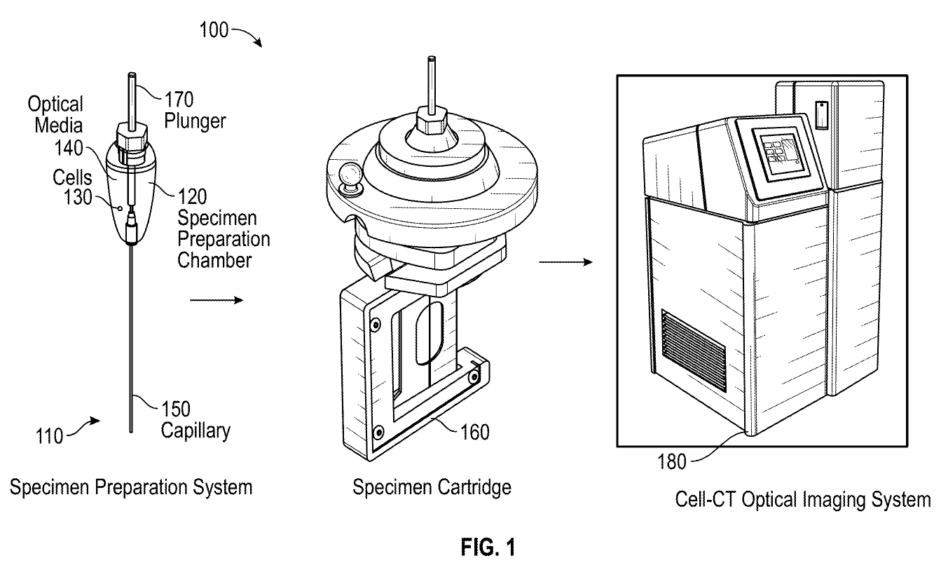

Referring now to FIG. 1, an exemplary specimen preparation system 110 of the calibration system 100 is shown. The specimen preparation system 110 includes a specimen preparation chamber (e.g. a PrepJet body) 120 that contains cells 130 suspended in optical media 140. The specimen preparation chamber 120 connects to a capillary 150 through which the cells 130 suspended in optical media 140 of the specimen preparation chamber 120 may be advanced. The optical media 140 of the specimen preparation chamber 120 has the same refractive index as the capillary 150 and other optical parts, such as the specimen cartridge 160. The plunger 170, which is controlled by the optical imaging system 180, typically pushes the suspended cells 130 through the capillary 150, where the cells 130 enter the optical path of the optical imaging system 180 for imaging.

In normal use, the capillary 150 connects to the specimen cartridge 160 of the specimen preparation system 110. The capillary 150 is threaded through a specially designed outer capillary of the specimen cartridge 160, which has flattened optically matched surface that nullifies any capillary curvature-induced distortion. The plunger 170 is secured by a seal, which enables the plunger 170 to hydraulically push the specimen (e.g., suspended cell 130) through the capillary 150.

In some embodiments of the calibration system, the optical imaging system 180 moves cells used two different mechanisms, (1) flow and (2) mechanical specimen cartridge motion. First, the optical imaging system 180 initiates the pushing the plunger 170 into the specimen cartridge 160. This causes the cells 130 that are to be imaged to flow through the capillary 150 in an optical path with the primary flow search position at an entry point of the imaging zone of the specimen cartridge 160, which is 8mm long. The flowing cells 130 in motion are detected using 2D image processing, and then cells of interest are tracked within the imaging zone of the capillary 150. The cells 130 of interest, as determined by a 2D image processing, cause the plunger 170 to retract, which drops the flow to near zero, well within the 8mm available to track cell flow. The first tracked cell in the optical path is then captured in 3D. The capillary 150 is then moved back to the entry flow position to search for any cells 130 of interest along the way that are then also captured in 3D. Once the capillary 150 is at the entry flow position, flow begins again to search for cells 130 of interest. When cells 130 of interest are identified, they are tracked to a stop, and the 3D imaging process is repeated.

In some embodiments of the calibration system 100, cells 130 are embedded in optical media 140 of the specimen preparation chamber 120 during a manufacturing process, where a suitably dense cell suspension is pushed through the capillary 150 until an acceptable number of cells 130 are resident within the 8mm capillary imaging zone of the specimen cartridge 160. The capillary 150 is removed from the specimen preparation chamber 120 and then sealed on both ends. The capillary 150 is attached to a solid epoxy-filled specimen preparation chamber 120 with a fixed plunger 170.

The specimen preparation chamber 120 is now a cell suspension with cells 130 pre-trapped within the 8mm imaging zone. No flow occurs during processing since the capillary 150 is threaded through an outer capillary of a specimen cartridge 160 for testing. The plunger 170 is connected as usual, but the optical imaging system 180 follows a specialized mode that does not engage pump motion. In the first step of the mechanical specimen cartridge motion, the optical imaging system 180 moves the specimen cartridge 160 through the 8mm imaging zone, recording the positions and 3D data of the embedded cells 130. In the second step of the mechanical specimen cartridge motion, the optical imaging system 180 records specimen features of cells 130 in the specimen cartridge 160, and compares them to known ranges for these imaged features on these cells from a known cell feature database.

In some embodiments of the calibration system 100, the cells 130 are embedded in optical media 140 at a concentration of ~2,500 cells/μl. In one non-limiting, example embodiment, the capillary inner diameter is 60μm, and the maximum travel distance is 8mm. This results in an expected 56 cells available for analysis in a calibration test. In other embodiments of the calibration system 100, larger or smaller capillary parameters may be implemented, and a longer or shorter maximum travel distance may be implemented.

For an effective calibration test of the optical imaging system 180 using the calibration system 100, the selected cells 130 fall within a middle range of an Abnormal Cell Classifier. Notably, an optical imaging system 180 with substandard imaging may produce images with lower contrast, reduced resolution, or optical artifacts. Common sources of imaging errors are optical alignment error, dirt, debris, or optical surface contamination. These issues typically lower the abnormal score of an imaged cell. However, since different failure modes exist, higher scores are also possible. To reliably detect shifts in performance, the calibration test of the optical imaging system 180 using the calibration system 100 should use cells with scores in the middle range, thus, enabling both increases and decreases in scores to be tracked.

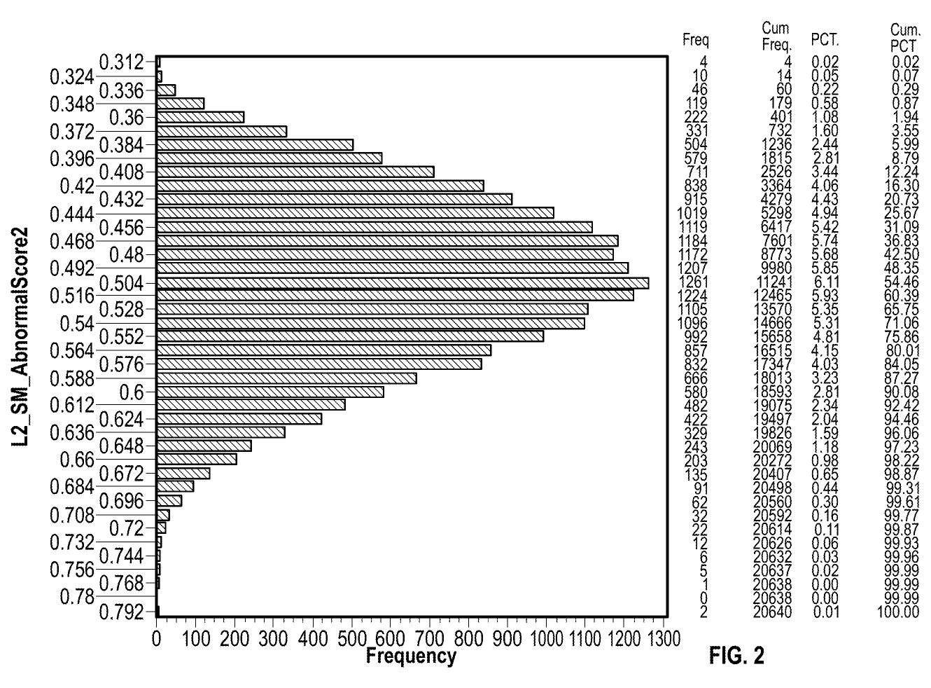

Sputum contains many types of cells, most of which score low on the abnormal classifier test. These include: (1) debris, (2) squamous cells, and (3) most bronchial epithelial cells. However, pulmonary macrophages are different. Since they are metabolically active, they exhibit chromatin patterns similar to abnormal cells, resulting in higher abnormal scores compared to other normal cells. To determine the typical score distribution of macrophages, cytologists examined randomly selected sputum cells. FIG. 2 shows a histogram of the abnormal scores for 20,640 macrophages, confirming that their scores fall within the middle range.

Although macrophages naturally occur in normal sputum, they are not abundant enough to ensure sufficient numbers for calibration analysis of the optical imaging system 180, which can include approximately 56 cells per test. To address this technological challenge, in some embodiments of the calibration system 100, sputum samples for macrophages are enriched using specialized biomarkers. One option for a specialized biomarkers is the MAC387 antibody marker with conjugated fluorophores from Santa Cruz Animal Health. In such an embodiment, the enriched cell pellet is embedded in optical media 140 following the standard procedures.

If naturally occurring macrophages are insufficient, alternative cells may be used. One such alternative example is cultured macrophage cell lines. In one such embodiment, macrophages are cloned and grown in culture using established cell lines, such as TIB-71 Macrophage Cell Line – ATCC. Another such alternative example is cancer cell lines. Some cancer cell lines may exhibit abnormal scores within the middle range. For example, one candidate in one implementation is a cancer cell line with less pronounced cancer features than the A549 adenocarcinoma cell line, which scores at the top of the range.

### Test Protocol

In some embodiments, the calibration system 100 employs a testing procedure to ensure the performance of an optical imaging system 180. The testing procedure of the calibration system 100 includes performing baseline testing with a new specimen preparation chamber 120. In one embodiment, the optical imaging system 180 processes a new specimen preparation chamber 120 by collecting image sets (e.g., 20 image sets) for all cells 130 in the 8mm capillary section. Next, a mean abnormal classifier score for all cells 130 is plotted. In one such embodiment, at least 30 cells must have scores between 0.2 and 0.8. In this embodiment, if fewer than 30 cells fall within this range, the specimen preparation chamber 120 is rejected. In other embodiments, a larger or smaller pre-set number of cells may be required to have scores between 0.2 and 0.8.

In one or more embodiments, the calibration system 100 next computes a baseline variability of the abnormal classifier score. In this regard, the calibration system 100 calculates the mean (μ) and standard deviation (σ) for all 20 image set test runs, using only cells 130 with abnormal classifier score scores between 0.2 and 0.8. The calibration system 100 then stores the average standard deviation: avg(σ). Additionally, in some embodiments, the calibration system 100 uses a coefficient of variance test (e.g., NIST Coefficient of Variance Test) to assess score stability. In some such embodiments, failure of this coefficient of variance test triggers a service request.

In some embodiments, the calibration system 100 then establishes a reference distribution by computing the mean (μ_{refdist}) and standard deviation (σ_{refdist}) of the LuCED abnormal score histogram, an example of which is illustrated in FIG. 2. Next, the calibration system 100 saves both the histogram and these values (e.g., the mean and standard deviation) for future reference.

Finally, in one or more embodiments, each optical imaging system 180 is assigned one specimen preparation chamber 120 for routine testing using the calibration system 100. In such embodiments, before performing any cell classification analysis using the optical imaging system 180, the calibration system 100 runs a calibration test using specimen preparation chamber 120 for routine testing using the calibration system 100 and compares the new histogram, mean (μ_{testdist}), and standard deviation (σ_{testdist}) values to the baseline. If the mean (μ_{testdist}) shifts outside the range (μrefdist ± 3 × avg(σ)), the test fails, and a recalibration of the optical imaging system 180 is required. Otherwise, the test passes, confirming the optical imaging system 180 is functioning properly and ready for laboratory usage.

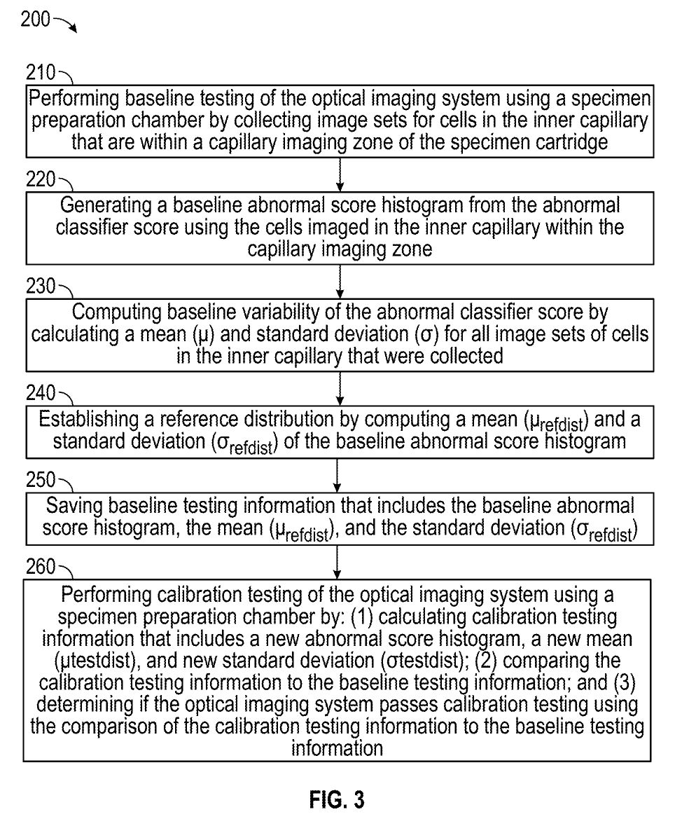

FIG. 3 is a logic diagram showing a method, 200 for calibrating an optical imaging system. As shown in FIG. 3, at operation 210, the method includes performing baseline testing of the optical imaging system using a specimen preparation chamber by collecting image sets for cells in the inner capillary that are within a capillary imaging zone of the specimen cartridge. At operation 220, the method includes generating a baseline abnormal score histogram from the abnormal classifier score using the cells imaged in the inner capillary within the capillary imaging zone. At operation 230, the method includes computing baseline variability of the abnormal classifier score by calculating a mean (μ) and standard deviation (σ) for all image sets of cells in the inner capillary that were collected. At operation 240, the method includes establishing a reference distribution by computing a mean (μ_{refdist}) and a standard deviation (σ_{refdist}) of the baseline abnormal score histogram. At operation 250, the method includes saving baseline testing information that includes the baseline abnormal score histogram, the mean (μ_{refdist}), and the standard deviation (σ_{refdist}). At operation 260, the method includes performing calibration testing of the optical imaging system using a specimen preparation chamber by: (1) calculating calibration testing information that includes a new abnormal score histogram, a new mean (μ_{testdist}), and new standard deviation (σ_{testdist}); (2) comparing the calibration testing information to the baseline testing information; and (3) determining if the optical imaging system passes calibration testing using the comparison of the calibration testing information to the baseline testing information.

### AI-Based Cell Classification System

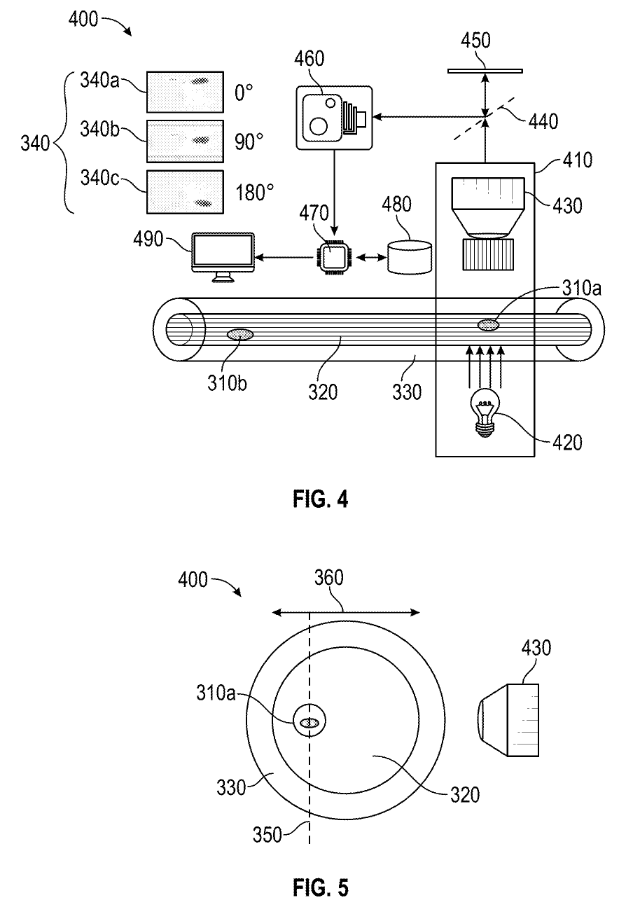

Referring now to FIG. 4 and FIG. 5, an AI-based cell classification system that is or has been calibrated by the calibration system 100 of the present disclosure or according to method 200 of the present disclosure may comprise an optical tomography system 400, which may be used to produce both 3D images and 2D images of a cell 310 (such as cell 310a or cell 310b). Although the operation of the optical tomography system is described for acquiring images of one cell 310, in a volume of optical medium in the optical path of a high-magnification microscope, images of multiple cells 310 within the same volume of optical medium may be acquired.

The optical tomography system 400 may include a cell imaging system 410, which includes an illumination source 420 optically coupled to an objective lens 430, such that illumination passes through the micro-capillary tube 330 and any intervening cell 310 before reaching the objective lens 430. The illumination then passes through the objective lens 430 to a beam-splitter 440, which causes part of the illumination to be deflected to a mirror 450 and reflected back to the beam-splitter 440 before being transmitted to a high-speed camera 460, and another part of the illumination to be transmitted directly through the beam-splitter 440 to the high-speed camera 460, to generate pseudo-projection images 340 of the cell 310 contained in an optical medium 320 in a micro-capillary tube 330. During 3D imaging, at least one pseudo-projection image 340 of the cell 310 is generated by scanning the volume occupied by the cell 310 by vibrating the mirror 450 in direction 360 (typically using an actuator, such as a piezo-electric motor, not shown), thus sweeping the plane of focus 350 through the cell 310 and then integrating the image to create the pseudo-projection image from a single perspective. Additional pseudo-projection images are obtained by rotating the micro-capillary tube 330. The pseudo-projection images are each a single image that represents a sampled volume that has an extent greater than the depth of field of the objective lens 430. The high-speed camera 460 generates, for each cell 310, a plurality of pseudo-projection images 340 that correspond to a plurality of axial micro-capillary tube rotation positions, examples of which are illustrated as 340a, 340b, and 340c in FIG. 4. In some embodiments, 500 pseudo-projection images are generated as the micro-capillary tube 330 is rotated through 360°.

In some embodiments, optical tomography system 400 is communicatively coupled to a processor 470 operable to receive the plurality of pseudo-projection images 340 from the high-speed camera 460 and use the pseudo-projection images 340 to generate a 3D image (not shown) of the cell 310. Images before or after manipulation by the processor 470 may be stored in communicatively coupled memory 480. The processor 470 may send data regarding the cell 310, or data relating to or derived from a plurality of cells 310 contained in a patient sample to a communicatively coupled output 490. Data sent to the output 490 may include 2D or 3D images of one or more cells 310, or a summary of cells in a patient sample analyzed by the optical tomography system 400, such as a graph or a table, an index, such as an abnormality index, reflecting the likelihood that the patient has or is at high risk for developing lung cancer, or even a simple indication that the sample is positive for cells indicative of lung cancer.

In embodiments disclosed herein shown in FIG. 4 and FIG. 5, the optical tomography system 400 may also be operated to generate a representative 2D image of the cell 310. In such embodiments, the objective lens 430 has a focal plane 350 that moves as the objective lens 430 sweeps across the micro-capillary tube 330 and any cell 310 in a back-and-forth direction 360 to produce a plurality of 2D images (not shown). This method of generating 2D images by moving the objective lens 430 is different than the method of producing 3D images using pseudo-projection images that are generated by vibrating the mirror 450. The processor 470 is operable to receive the plurality of 2D images and determine a representative 2D image of the cell 310. In some embodiments, the representative 2D image of the cell 310 is an image of the central portion, such as the center) of the cell. The processor 470 is then further operable to perform AI-based cell classification of the representative 2D image using 2D cell classifiers as described herein to determine if the cell 310 has abnormal features or bronchial epithelial cell (BEC)-like features, or does not have abnormal features or BEC-like features. Only when the cell 310 is determined to have abnormal features or to have BEC-like features does the processor 470 direct the cell imaging system 410 to generate pseudo-projection images 340 of the cell 310.

In some embodiments, the cell imaging system 410 includes the illumination source 420, the objective lens 430, the beam-splitter 440, mirror 450, and the high-speed camera 460.

In some embodiments, the optical tomography system 400 further includes the processor 470, any communicatively coupled memory 480, and the communicatively coupled output 490. In certain embodiments, the optical tomography system 400 further includes the micro-capillary tube 330, the optical medium 320, or one or more cells 310, but in other embodiments, the optical tomography system 400 does not include one or more of these potential components, although they may be supplied for operation of the system.

In certain embodiments, the AI-based cell classification system 400 is operable to generate images in at least two distinct modes. One mode includes a cell search mode, during which 2D images of a cell 310 are generated and processed to generate a representative 2D image, which is then used to determine whether the cell 310 has abnormal features or BEC-like features. As shown in FIG. 5, 2D images in this mode are generated by moving the objective lens 430 in direction 360 to sweep the focal plane 350 through the cell. A second mode includes a projection image capture mode, during which pseudo-projection images 340 are generated and used to produce a 3D image of the cell 310 if the cell 310 has been determined to have abnormal features or BEC-like features during the cell search mode. 3D images in this mode are generated by vibrating the mirror 450 in direction 360 to create the pseudo-projection images 340.

### Lung Cancer Detection Methods

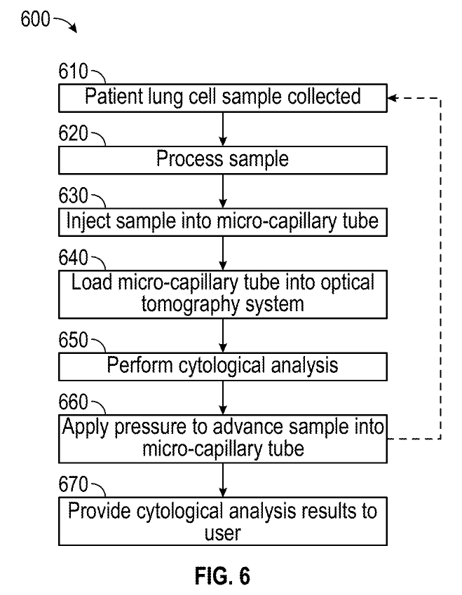

FIG. 6 depicts a lung cancer detection method 600, which may be performed using an optical tomography system, such as the optical tomography system 400, which has been calibrated using calibration system 100 or according to method 200. Elements of the optical tomography system 400 are referenced in this description of the lung cancer detection method 600 as examples. Similar components of different optical tomography systems may also be used in connection with the lung cancer detection method 600.

The lung cancer detection method 600 includes a step 610 in which a lung cell sample is collected from a patient. For example, the lung cell sample may be sputum, although other sample types, such as samples obtained by bronchoalveolar lavage (BAL), nasal swab, or biopsy may also be used. In some embodiments, particularly for the detection of other cancers or abnormal cells, samples may include urine or blood.

Samples may undergo an AI-based cell classification method 600 at any time during which cells are not to have degraded to the point where limited cellular content remains. The duration of such time may depend on the storage conditions, e.g., whether the sample is refrigerated or how or if the sample is processed. In some embodiments, the sample may undergo the AI-based cell classification method 600 within 30 minutes, one hour, two hours, 6 hours, 12 hours, one day, two days, one week, or two weeks of collection.

Particularly in the case of sputum samples, the patient sample may include many cell types that are not likely to be indicative of lung cancer, such as white blood cells, including polymorphonuclear leukocytes, monocytes, and lymphocytes, cell clusters, oral squamous cells, and squamous intermediate cells. The sample also typically will contain a substantial amount of non-cellular debris or cell fragments.

In some embodiments, the sample contains abnormal cells, BECs, squamous cells, monocytes, lymphocytes, polymorphonuclear leukocytes, other white blood cells, debris, cell fragments, cell clusters and any combinations thereof.

In step 620 the sample is processed for analysis. Processing may optionally include staining to render any of the plurality of cells 310 or any features, such as the nucleus of any of the plurality of cells 310, easier to detect using the optical tomography system 400, or otherwise staining or treating the cells with an agent that facilitates generating the representative 2D image, evaluating the representative 2D image using an abnormal cell 2D classifier, evaluating the representative 2D image using a BEC 2D classifier, generating a 3D image of the cell, or analyzing a 3D image of the cell. In specific embodiments, the cells may be stained with hematoxylin.

Processing may optionally include, alone or in combination with staining, enrichment of the sample for cells of interest. For example, in some embodiments, the sample is enriched for BECs.

In one embodiment, the sample may be enriched for BECs by staining cytoskeleton proteins and using fluorescently activated cell sorting (FACS)-based enrichment.

In one embodiment, BEC enrichment may include treating the sample with at least one antibody, and typically a plurality of antibodies, having fluorescent conjugates that may be used for FACS-based enrichment. In particular, the antibodies may bind to BECs or they may bind contaminating inflammatory cells, such a neutrophils and macrophages. Antibodies that bind contaminating inflammatory cells may include anti-CD45 antibodies. In some embodiments, the sample is treated with a combination of antibodies that bind to BECs and antibodies that bind contaminating inflammatory cells, with the antibodies having distinct fluorescent conjugates.

In one embodiment, the cells may be stained with 4′,6-diamidino-2-phenylindole (DAPI) alone or in combination with antibodies for FACS-based cell enrichment purposes as well.

Cells may be enriched by FACS in which gating is used to exclude DAPI-positive materials (which tend to be doublet cells or debris), high side-scatter objects, objects bound by anti-inflammatory cell antibodies, or any combinations thereof. Cells may also be enriched by FACS in which gating is used to select cells that are bound by anti-BEC antibodies. In some embodiments, both exclusive and inclusive gating may be used and may be implemented concurrently or in series.

Following any optional staining or enrichment, the sample processing 620 includes placing the cells 310 contained in the sample in an optical medium 320.

The optical medium 320 may be any medium reasonably expected to maintain the cells 310 intact during the expected duration of time prior to and during the AI-based cell classification 600. The optical medium 320 may also have a viscosity that allows movement of the optical medium 320 through a micro-capillary tube 330. The optical medium 320 may also not interfere with image generation by the optical tomography system 400. In particular, the optical medium may have an optical index that matches the optical index of other components of the optical tomography system 400 and the micro-capillary tube 330 through which light passes during image acquisition. Typically, the optical tomography system 400 components through which light passes and the micro-capillary tube 330 also have a matching index. For optimal optical tomography operation, any changes in light movement should be due to encountering the object to be imaged, not changes in the optical index of other components or objects in the light path.

In the step 630, the optical medium 320 containing a plurality of cells 310 from the patient sample is injected into a micro-capillary tube 330. In some embodiments, the micro-capillary tube 330 may have an outer diameter of 500 µm or less, for example, between 30 µm and 500 µm. In some embodiments, the micro-capillary tube 330 may have an inner diameter of 400 µm or less, for example, between 30 µm and 400 µM, such as 50 µm. In one embodiment, the entire portion of the patient sample to be analyzed is placed in one micro-capillary tube 330. In another embodiment, the portion of the patient sample to be analyzed is placed in a plurality of micro-capillary tubes 330, which may undergo the AI-based cell classification method 400 sequentially. In still another embodiment, the sample may be pumped through the micro-capillary tube 330 from a sample reservoir.

In the step 640, the micro-capillary tube 330 is loaded into the optical tomography system 400, so that the micro-capillary tube 330 is between the illumination source 420, and the objective lens 430.

In step 650 the optical medium 320 and any cells 310 contained within it are advanced into (prior to the initial step 640) or through the micro-capillary tube 330 by applying pressure at one end of the micro-capillary tube, such that a different volume of the optical medium 320 carrying a different portion of the patient sample is in the optical path of the optical tomography system 400, between the illumination source 420 and the objective lens 430. In some embodiments, a plunger (not shown) is used to advance the optical medium 320. For instance, a plunger may be applied to a reservoir (not shown) of the optical medium 320 and patient sample that is connected to the micro-capillary tube 330, forcing additional optical medium 320 from the reservoir into the micro-capillary tube 330.

In step 660, it is determined whether a pre-selected number of cells having BEC-like features have been 3D imaged. If the pre-selected number has been reached, the process moves on to step 670. Otherwise, the process returns to step 650 and advances the sample in the micro-capillary tube.

In step 670, images of cells selected for 3D imaging are provided to a user, for example, using the output 490. Results may include results specific for an individual cell 310, such as the 3D image of cell 310. AI-based cell classification results may also include data based upon the analysis of all or a portion of the patient sample or plurality of cells 310, such as an abnormality index and/or a cancer threshold value. For example, the AI-based cell classification results may include a list or other indication of individual cells 310 found to have abnormal features or BEC-like features or otherwise marked according to pre-selected criteria for further review of the 3D image by the user. The AI-based cell classification results may include graphical, statistical, or numerical information, such as the number of cells detected (typically the total enumerated analyzed cells), the number of cells for which a 3D image was generated, the number of enumerated cells having abnormal features, the number of enumerated cell having BEC-like features, or the relative proportions of any of these groups of cells. The AI-based cell classification results may also contain information regarding the predicted accuracy. The AI-based cell classification results may include an index, such as an abnormality index, reflecting the likelihood that the patient has or is at high risk for developing lung cancer, or even a simple indication that the sample is positive for cells indicative of lung cancer. Sample identification data may also be provided with the AI-based cell classification results.

### Examples

### Example 1

### Training of 2D cell classifiers

A lung cancer detection method was implemented using a CELL-CT^{®} optical tomography system. The lung cancer detection method was designed to detect lung cancer in a pre-invasive stage, when treatment is easier and more likely to be successful.

The following method was used:

1. Patient sample for testing was fixed, stained and enriched for BECs.

2. Patient sample was then suspended in an oil-based optical medium. The cells in the optical medium were then inserted into a glass micro-capillary tube of approximately 60µm inner diameter. Pressure was applied to the medium to move the cells into the optical path of a high-magnification microscope in the optical tomography system. (See FIG. 3).

3. Once the cells were in the optical path of the high-magnification microscope, cell search mode was initiated. When in Cell Search mode the CELL-CT^{®} continuously swept its plane of focus, in 1 µm steps, through the lumen of the micro-capillary tube to identify the linear, radial and angular position of cells. Detected dark objects beyond a certain size were identified for potential 3D capture. The 2D image set was filtered to take the central image of a cell. This 2D image was then evaluated using the 2D cell classifiers to determine if the cell had abnormal features or BEC-like features as described below.

4. Each cell was also analyzed in projection image capture mode, during which the tube was rotated so that the optical tomography system generated 600 high-resolution images of the same diagonal cross-section of the capillary tube, taken over 360 degrees of tube rotation. These images were pseudo-projection images, which are simulations of projection images created by integrating the light from the objective lens as the focal plane was swept through the nucleus of any cell contained in the images. The pseudo-projection images thus represented the entire nuclear content in a single image, taken from a single perspective.

5. Pseudo-projection images were processed to correct for residual noise and motion artifact.

6. The corrected pseudo-projection images were processed using filtered back projection to yield a 3D tomographic representation of the cell, also referred to as a 3D image. 3D tomographic representations were created for a substantial number of cells, including multiple cells identified in an optical medium volume within the optical path of the high-magnification microscope before the optical medium is advanced to a different volume by pressure. An example of such a 3D image for both squamous intermediate and dysplastic cells.

7. The 3D images were evaluated by a cytopathologist to determine if the cell was abnormal, a BEC, or normal, or not a BEC.

Meyer, M.G., et al. (2015), The CELL-CT^{®} 3-dimensional cell imaging technology platform enables the detection of lung cancer using the noninvasive LuCED sputum test. Cancer Cytopathology, 123: 512-523 (doi.org/10.1002/cncy.21576); Wilbur, D.C., et al. (2015), Automated 3-dimensional morphologic analysis of sputum specimens for lung cancer detection: Performance characteristics support use in lung cancer screening. Cancer Cytopathology, 123: 548-556 (doi.org/10.1002/cncy.21565); US 6519355, US 6522775, US 6591003, US 6636623, US 6697508, US7197355, US 7494809, US 7569789, US 7738945, US 7811825, US 7835561, US 7867778, US 7787112, US 7907765, US 7933010, US 8090183, US 8155420, US 8947510, US 9594072, US10753857, US11069054, and US20200018704, are each incorporated by reference herein in its entirety and specifically as it relates to the components, basic operation, including potential cell staining and enrichment, image formation, including formation of pseudo-projection images, and 3D classifiers of optical tomography systems and lung cancer detection methods and systems described herein.

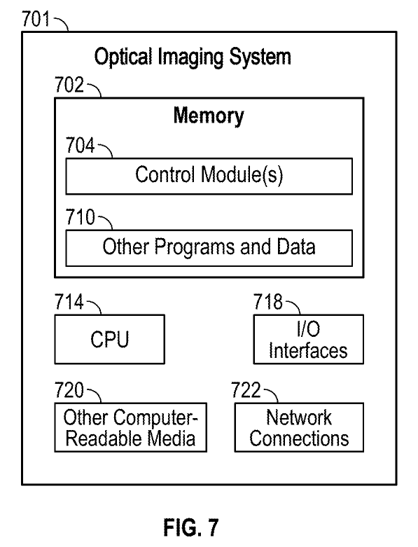

FIG. 7 shows a system diagram that describes an example implementation of a computing system(s) for implementing embodiments described herein. The functionality described herein for a system for a method for providing equivalent services that can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, allowing higher deployment agility and flexibility.

In particular, shown is example optical imaging system 701 (e.g., the CT optical imaging system 180 shown in FIG. 1). For example, such optical imaging system 701 may represent those in various data centers and/or described herein that host the functions, components, microservices and other aspects described herein to implement a method for providing equivalent services to user devices across multiple participating telecommunication networks. In some embodiments, one or more special-purpose computing systems may be used to implement the functionality described herein. Accordingly, various embodiments described herein may be implemented in software, hardware, firmware, or in some combination thereof. Host optical imaging system 701 may include memory 702, one or more central processing units (CPUs) 714, I/O interfaces 718, other computer-readable media 720, and network connections 722.

Memory 702 may include one or more various types of non-volatile and/or volatile storage technologies. Examples of memory 702 may include, but are not limited to, flash memory, hard disk drives, optical drives, solid-state drives, various types of random-access memory (RAM), various types of read-only memory (ROM), other computer-readable storage media (also referred to as processor-readable storage media), or the like, or any combination thereof. Memory 702 may be utilized to store information, including computer-readable instructions that are utilized by CPU 714 to perform actions, including those of embodiments described herein.

Memory 702 may have stored thereon control module(s) 704. The control module(s) 704 may be configured to implement and/or perform some or all of the functions of the systems, components and modules described herein for a method for providing equivalent services to user devices across multiple participating telecommunication networks. Memory 702 may also store other programs and data 710, which may include rules, databases, application programming interfaces (APIs), software platforms, cloud computing service software, network management software, network orchestrator software, network functions (NF), AI or ML programs or models to perform the functionality described herein, user interfaces, operating systems, other network management functions, other NFs, and the like.

Network connections 722 are configured to communicate with other computing devices to facilitate the functionality described herein. In various embodiments, the network connections 722 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 718 may include a video interface, other data input or output interfaces, or the like. Other computer-readable media 720 may include other types of stationary or removable computer-readable media, such as removable flash drives, external hard drives, or the like.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise.

In the present description, any concentration range, percentage range, ratio range, or integer range is to be understood to include any values or subranges within the recited range unless otherwise indicated. It should also be noted that the term “or” is generally employed in its sense including “or” (i.e., to mean either one, both, or any combination thereof of the alternatives) unless the content dictates otherwise. Also, as used in this specification and the appended claims, the singular forms “a,” “an,” and “the” include plural referents unless the content dictates otherwise. The terms “include,” and “have” and their variants are used synonymously and are to be construed as non-limiting. The term “a combination thereof” as used herein refers to all possible combinations of the listed items preceding the term. For example, “A, B, C, or a combination thereof” is intended to refer to any one of: A, B, C, AB, AC, BC, or ABC. Similarly, the term “combinations thereof” as used herein refers to all possible combinations of the listed items preceding the term. For instance, “A, B, C, and combinations thereof” is intended to refer to all of: A, B, C, AB, AC, BC, and ABC.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including U.S. Patent Application Serial No. 63/394,550, filed August 2, 2022, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system for calibrating an optical imaging system, wherein baseline testing of the optical imaging system is performing on image sets for cells that are within a capillary imaging zone of a specimen cartridge, comprising:
a specimen preparation chamber containing cells suspended in an optical media, the specimen preparation chamber including a first port at a first end of the specimen preparation chamber and a second port at a second end of the specimen preparation chamber, the first end of the specimen preparation chamber being opposite of the second end of the specimen preparation chamber;
an inner capillary connected to the first port of the specimen preparation chamber, wherein the inner capillary has an inner lumen, and wherein the cells suspended in the optical media of the specimen preparation chamber may be advanced through the first port and the inner lumen of the inner capillary;
wherein the optical media of the specimen preparation chamber has the same refractive index as the inner capillary; and
a plunger connected to the second port of the specimen preparation chamber, wherein the plunger is controllable by the optical imaging system, and wherein the plunger is configured to push the suspended cells through the first port and the inner lumen of the inner capillary where the cells enter an optical path of the optical imaging system for imaging of the cells,
wherein the cells remain in a native three dimensional shape in the inner capillary for imaging rather than being flatten into a two dimensional shape on a slide for imaging.

2. The system of claim 1, wherein the inner capillary is configured to be threaded through an outer capillary of the specimen cartridge into the capillary imaging zone of the specimen cartridge.

3. The system of claim 1, wherein an outer capillary of the specimen cartridge has a flattened optically matched surface that attenuates any capillary curvature induced distortion.

4. The system of claim 3, wherein the optical media of the specimen preparation chamber has a same refractive index as the specimen cartridge.

5. The system of claim 1, wherein the inner capillary has a first end and a second end, wherein the inner capillary receives suspended cells through the first end that are transferred from the optical media of the specimen preparation chamber, and wherein the inner capillary is removed from the specimen preparation chamber after receiving the suspended cells and sealed at the first end and the second end, after which the inner capillary is attached to the specimen preparation chamber with the fixed plunger.

6. The system of claim 1, wherein the cells suspended in an optical media of the specimen preparation chamber are pulmonary macrophages, wherein the pulmonary macrophages are metabolically active and exhibit chromatin patterns similar to abnormal cells.

7. The system of claim 6, wherein the pulmonary macrophage cells suspended in the optical media of the specimen preparation chamber are enriched using a specialized biomarker.

8. The system of claim 7, wherein the specialized biomarker is a MAC387 antibody marker with conjugated fluorophores.

9. A method for calibrating an optical imaging system, comprising:
performing baseline testing of the optical imaging system using a specimen preparation chamber by collecting image sets for cells in an inner capillary that are within a capillary imaging zone of a specimen cartridge;
generating a baseline abnormal score histogram from an abnormal classifier score using the cells imaged in the inner capillary within the capillary imaging zone;
computing baseline variability of the abnormal classifier score by calculating a mean (μ) and standard deviation (σ) for all image sets of cells in the inner capillary that were collected;
establishing a reference distribution by computing a mean (μ_{refdist}) and a standard deviation (σ_{refdist}) of the baseline abnormal score histogram;
saving baseline testing information that includes the baseline abnormal score histogram, the mean (μ_{refdist}), and the standard deviation (σ_{refdist}); and
performing calibration testing of the optical imaging system using a specimen preparation chamber by:
calculating calibration testing information that includes a new abnormal score histogram, a new mean (μ_{testdist}), and new standard deviation (σ_{testdist});
comparing the calibration testing information to the baseline testing information; and
determining if the optical imaging system passes calibration testing using the comparison of the calibration testing information to the baseline testing information.

10. The method of claim 9, wherein a control system for the optical imaging system moves cells through the inner capillary using flow generated by a plunger, and mechanical motion of the specimen cartridge.

11. The method of claim 9, wherein an abnormal cell classifier of the optical imaging system includes a lower range, a middle range, and an upper range; and further comprising: selecting cells to be suspended in an optical media of the specimen preparation chamber that fall within the middle range of an abnormal cell classifier when calibrating an abnormal cell classifier of the optical imaging system.

12. The method of claim 9, wherein at least thirty cells are imaged in the inner capillary within the capillary imaging zone having mean abnormal classifier scores between 0.2 and 0.8.

13. The method of claim 9, wherein if less than thirty cells are imaged in the inner capillary within the capillary imaging zone having mean abnormal classifier scores between 0.2 and 0.8, then the specimen preparation chamber is rejected.

14. The method of claim 9, wherein the computation of the baseline variability is calculated using cells with abnormal classifier scores between 0.2 and 0.8.

15. The method of claim 9, wherein the calibration system calculates and stores an average standard deviation: avg(σ).

16. The method of claim 9, further comprising: using a coefficient of variance test to assess score stability.

17. The method of claim 16, wherein failure of the coefficient of variance test triggers failure of the optical imaging system calibration, and recalibration of the optical imaging system.

18. The method of claim 9, further comprising: determining that the calibration test fails when a mean (μ_{testdist}) shifts outside a range of μ_{testdist} ± 3 × avg(σ).

19. The method of claim 9, further comprising: requiring a recalibration of the optical imaging system, in response to determining that the calibration test fails.

20. A system for calibrating an optical imaging system, comprising:
a specimen preparation chamber containing cells suspended in an optical media, the specimen preparation chamber including a first port at a first end of the specimen preparation chamber and a second port at a second end of the specimen preparation chamber, the first end of the specimen preparation chamber being opposite of the second end of the specimen preparation chamber;
an inner capillary connected to the first port of the specimen preparation chamber, wherein the inner capillary has an inner lumen, and wherein the cells suspended in the optical media of the specimen preparation chamber may be advanced through the first port and the inner lumen of the inner capillary;
wherein the optical media of the specimen preparation chamber has the same refractive index as the inner capillary;
a plunger connected to the second port of the specimen preparation chamber, wherein the plunger is controllable by an optical imaging system, and wherein the plunger is configured to push the suspended cells through the first port and the inner lumen of the inner capillary where the cells enter an optical path of the optical imaging system for imaging of the cells,
wherein the cells remain in a native three dimensional shape in the inner capillary for imaging rather than being flatten into a two dimensional shape on a slide for imaging; and
a calibration control system having a memory that stores computer-executable instructions and a processor that executes the computer-executable instructions and causes the processor to:
perform baseline testing of the optical imaging system using a specimen preparation chamber by collecting image sets for cells in the inner capillary that are within a capillary imaging zone of a specimen cartridge;
generate a baseline abnormal score histogram from an abnormal classifier score using the cells imaged in the inner capillary within the capillary imaging zone;
compute baseline variability of the abnormal classifier score by calculating a mean (μ) and standard deviation (σ) for all image sets of cells in the inner capillary that were collected;
establish a reference distribution by computing a mean (μ_{refdist}) and a standard deviation (σ_{refdist}) of the baseline abnormal score histogram;
save baseline testing information that includes the baseline abnormal score histogram, the mean (μ_{refdist}), and the standard deviation (σ_{refdist}); and
perform calibration testing of the optical imaging system using a specimen preparation chamber by:
calculate calibration testing information that includes a new abnormal score histogram, a new mean (μ_{testdist}), and new standard deviation (σ_{testdist});
compare the calibration testing information to the baseline testing information;
determine if the optical imaging system passes calibration testing using the comparison of the calibration testing information to the baseline testing information; and
initiating recalibration of the optical imaging system, in response to determining that the calibration test fails.
